(19) United States
(12) Patent Application Publication
(10) Pub. No.: US 2018/0229993 A1
(43) Pub. Date: Aug. 16, 2018

(54) COMBINATION FUEL AND ADDITIVE TRAILER

(71) Applicant: Loren Van Wyk, Pella, IA (US)

(72) Inventor: Loren Van Wyk, Pella, IA (US)

(21) Appl. No.: 15/892,522

(22) Filed: Feb. 9, 2018

Related U.S. Application Data
(60) Provisional application No. 62/458,355, filed on Feb. 13, 2017.

(51) Int. Cl. B67D 7/02; B67D 7/58; B67D 7/38; B67D 7/78; B67D 7/80; B67D 7/84; F01N 3/28

(52) U.S. Cl. CPC B67D 7/02; B67D 7/58; B67D 7/38; B67D 7/0294; B67D 7/80; B67D 7/84; F01N 3/2896; B67D 7/78

(57) ABSTRACT

This invention pertains to the field of fuel storage and transport and, more particularly, to an assembly employed to transport at least two different fluids, comprising means to heat and maintain the temperature of at least one of the fluids, independently of the temperature of the other fluid. The assembly may include a container for each of the different fluids, and means to heat may include an active heater or simply employ heat provided by operation of an associated motor, combined with a conduit positioned along a surface of one of the containers. The assembly further comprises means to load and to off-load each fluid, separately.

### CROSS REFERENCE TO RELATED APPLICATIONS

This application claims the benefit of U.S. Patent and Trademark Office Provisional Application No. 62/458,355 which was filed on Feb. 13, 2017, the entirety of which is incorporated herein by reference.

### BACKGROUND

### 1. Field of Invention

This invention pertains to the field of fuel storage and transport and, more particularly, to means for transporting at least two different fluids and comprising means to load and to off-load each fluid, separately

### 2. Description of the Prior Art

Fuel storage and transport are challenges faced by many industries. The fuel often is dangerous to the environment if accidental spills occur, typically have a level of flammability that requires equipment specially constructed to minimize the likelihood of sparks, and may become too viscous for convenient use when the temperature drops. Further, fuel is used by operation of machines. The location where the machine is employed may be quite remote from the source of fuel, or the machine employing the fuel may not be road ready or otherwise equipped to be efficiently transported to a place where it can be refueled.

One way of addressing the challenges herein described includes the use of fuel trailers. These trailers comprise a hitch and wheels, and are moved to the location where the fuel is needed.

Alternatively, a truck mounted fuel tank may be employed, often including a pump to move the fuel out of the truck mounted fuel tank, and an opening in the fuel tank through which fuel can be loaded.

Some fuels are temperature sensitive. For example, diesel exhaust fluid (DEF) starts to become viscous and unusable for most diesel engines at about 23F and, generally, should be maintained at or above about 25F for usability, at least for diesel powered motors. Some machines require the inclusion of additives such as DEF injected into the exhaust system to clean the exhaust or to increase efficiency of fuel use. In these cases, the fuel tank and any storage tank in which the DEF is stored usually will require heating means to maintain the additive at temperatures at which it is optimally operational.

### SUMMARY

The present invention comprises an assembly to be mounted on a vehicle, in a truck bed or in a trailer. Exemplary embodiments may include mounting and/or associating the assembly with the bed of a pickup. However, the assembly could, instead, be enclosed by or mounted on a trailer to be towed, or on a wheeled platform, or on a skid to be secured on a wheeled platform or trailer.

The present assembly comprises, generally, a lower assembly having at least a first container which may be a fuel container and, optionally, a second container which may be an additive container, and an upper assembly. The lower assembly is equipped to move or to allow movement of the fuel and the additive in and out of the first and second containers, separately and respectively. Movement of the fuel may be accomplished by employing a fluid delivery assembly having a reversible motor or a single-direction pump, and a conduit associated with the fuel container thereby facilitating movement of fluid into and/or out of the fuel container. Where a reversible motor is employed, the direction of flow of the fuel in the conduit is controlled by the direction of the motor and may be caused to flow in either direction. Alternatively, a valve may be employed to allow flow of the fuel into or out of the container. One or more 4-way valves may be employed each having three positions: open for a first direction of flow; open for a second direction of flow; and closed so no fluid flows. In the latter scenario, the motor is not required to be reversible.

The fluid delivery assembly is designed to facilitate heat conduction so as to impart heat to one or both of the containers to facilitate proper storage conditions or adequate fluidity for ease of pumping. Heat from a motor associated with the fluid delivery assembly may provide adequate heat as may heating elements, fans, etc., be employed to facilitate heat transfer. In some embodiments, the elements of the fluid delivery assembly are arranged so as to form troughs, conduits, or other heat directing means; in other embodiments, the fluid delivery assembly comprises conduit members in the construction of the assembly to move heated are past at least one of the containers in which fuel and/or additive is transported.

In one embodiment, each of the first container and the second container are provided a separate pumping means. The pumping means for the containers may be identical or may be sized according to the expected ratio of use of the two fluids stored separately in the containers, or according to the relative volumes of the respective fluids taking into account the relative viscosities of the fluid stored in each, and/or the relative volumes of each container and/or relative speed of the pump relative to those containers. Optionally, one or both pumping means may comprise a 4-way valve or may be associated with a reversible motor, in either case, to allow pumping into or out of each of the respective containers.

In a preferred embodiment, flexible conduits are provided for transporting the fluid from each of the containers. Further, a heating means is provided to maintain the fluid in one or both of the tanks at a desired temperature. In a preferred embodiment, the fluid delivery assembly may be equipped with directional sleeves for ease of storing the conduits.

### BRIEF DESCRIPTION OF THE DRAWINGS

The disclosure will be better understood and when consideration is given to the drawings and the detailed description which follows. Such description makes reference to the annexed drawings wherein:

FIG. 1 is a perspective view of an assembly of the present invention;

FIG. 2 is a perspective view of the first container;

FIG. 3 is an exploded, perspective view of the assembly of the present invention showing how the second container may be associated with the first container, and the first end and the second end;

FIG. 4 is a view of the second end of the assembly showing the heater and pumps in accordance with an example of the invention;

FIG. 5 is a view of the first end of the assembly showing the fill nozzles;

FIG. 6 shows the directional conduit sleeve and conduit;

FIG. 7 shows the directional conduit sleeve and conduit being inserted into the conduit storage area for storage during nonuse;

FIG. 8 shows the second end of the assembly, without the heater and pumps, and including the heat conduit

FIG. 9 provides a close up view of FIG. 8, featuring the heat conduit;

FIG. 10 shows a perspective view of the assembly with the heat conduit's position ghosted.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a fluid delivery assembly equipped with at least one and, preferably more than one, container to house at least one kind of fluid, means to move a fluid either into or out of said container, and, if needed, an embodiment may include means to manage the temperature of fluid in at least one of said containers.

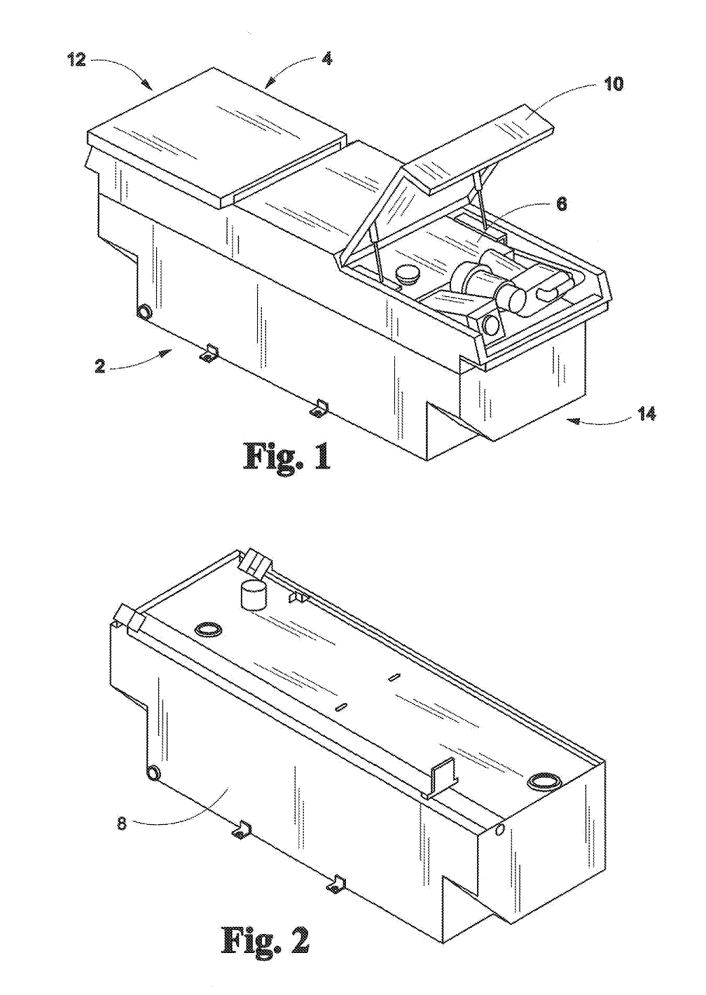

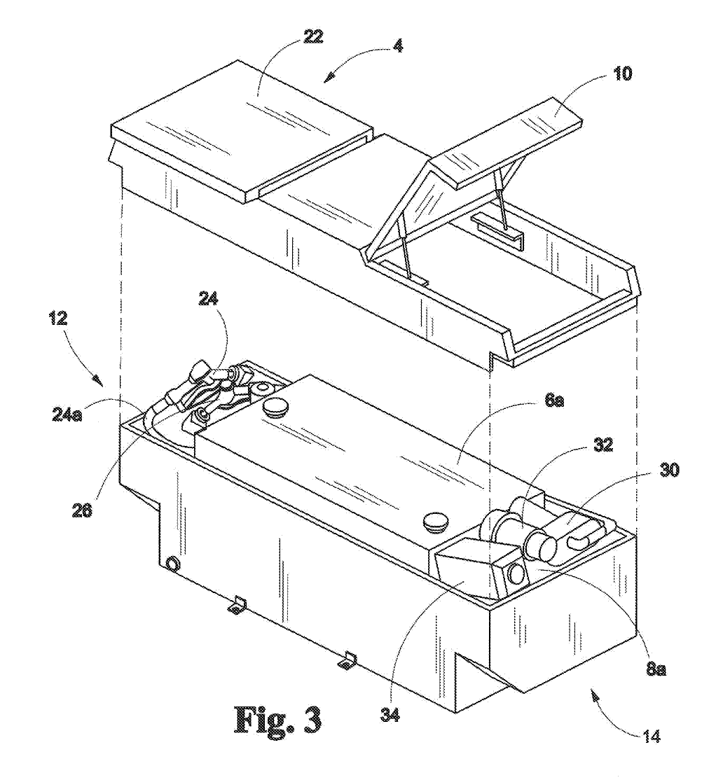

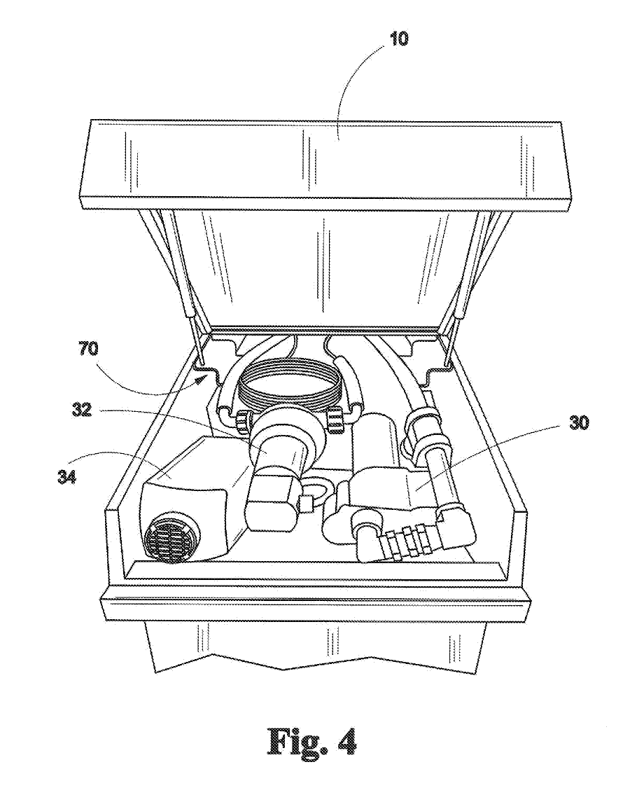

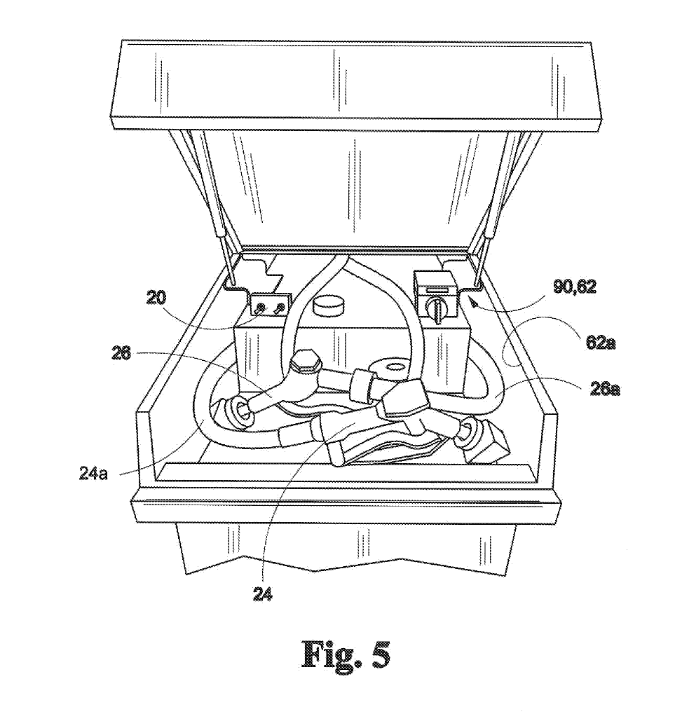

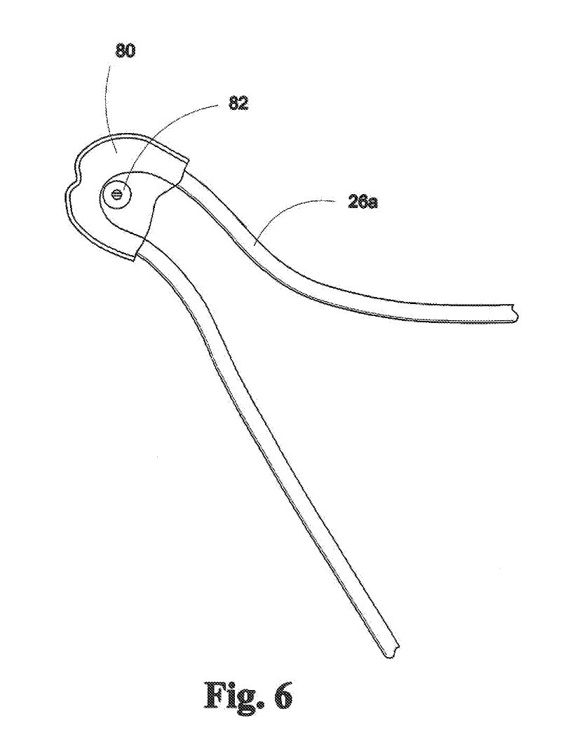

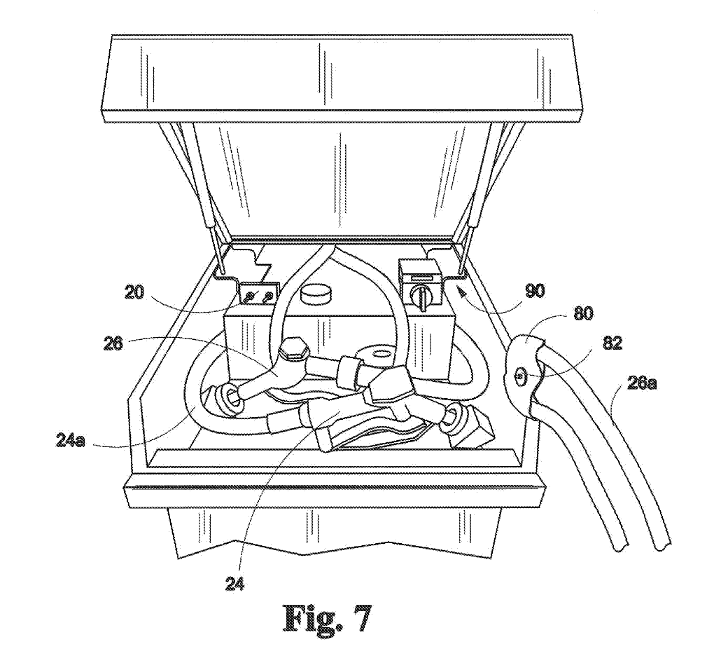

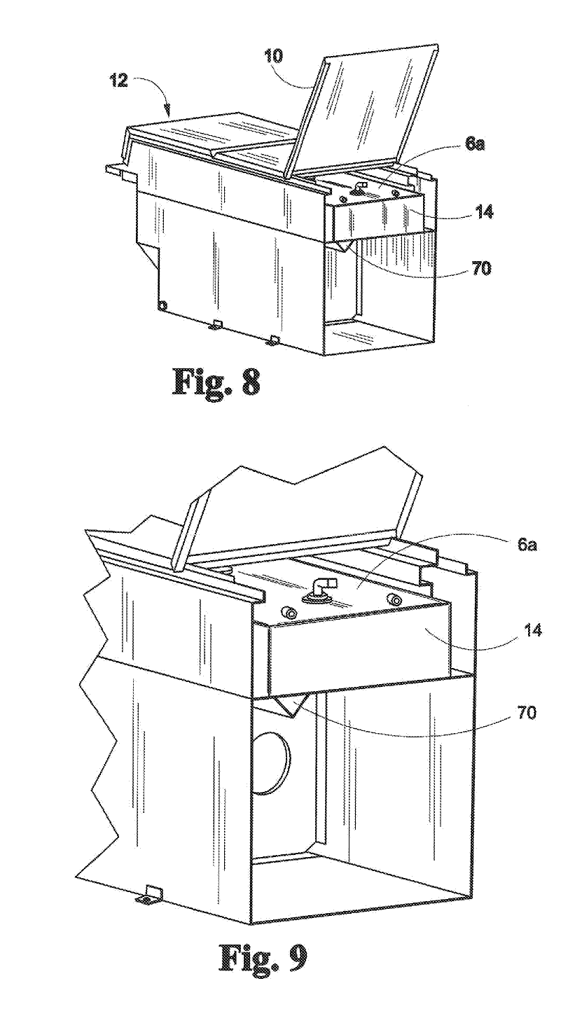

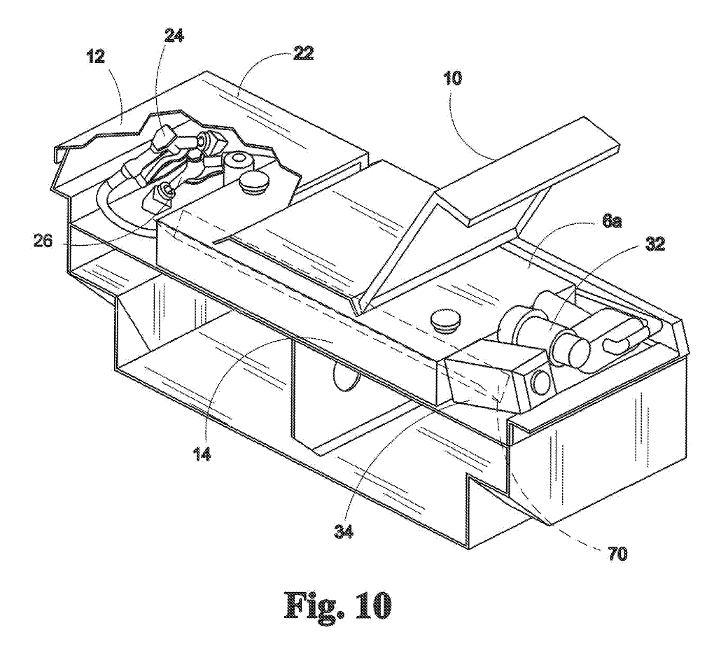

FIG. 1 is perspective view of a fluid delivery device 100 of the present invention comprised of a lower assembly 2 and an upper assembly 4. For example, in the nonlimiting example of FIG. 1, the upper assembly 4 acts as a cover over a first container 6 (FIG. 2) and a second container 8 (FIG. 3) and preferably comprises at least one access door 10. The lower assembly 2 comprises the first container 6 which may be a fuel tank 6, and the second container 8 which may be a second fuel tank or additive tank 8, a first end 12 and a second end 14, as shown in FIG. 1. The first end 12 may comprise a tank fill 16 which may be as simple as an opening with means to close where fluid can be poured or pumped into the tank, a switch or switches 20, and a nozzle access 10 for nozzles 24 and 26 (see FIG. 8 and FIG. 3). The second end 14 may include a fuel pump 30 and an additive pump 32. FIGS. 8 and 9 show the fluid delivery device preferably includes means to convey heat 70. The heat conveyed may be generated as a byproduct of a pump motor or may be produced by a heater or heating element, or simply by virtue of convection and the temperature difference between the two tanks. In any case, the means to convey heat may comprise a conduit 70. The conduit 70 may be formed as part of the construction of one or both of the tanks 6, 8, or may be in heat transfer relationship with one or both of the tanks 6,8 bringing the heated air from the pump motor, heater, or heating element 100 to one or both of the tanks 6, 8.

In FIG. 2, the upper assembly 4 has been removed revealing the second tank or container 8 positioned over the first tank or container 6. However, the relative positions of the tanks are not so limited; side by side would also work well as would one tank partially surrounding the other so long as means to convey heat 70 (which may comprise gas, liquid or any material capable of being moved and transferring its heat to the second container/tank 8). In one embodiment, temperature control means 34a are positioned so as to provide heat as necessary to the second container/tank 8. FIG. 2 again shows the nozzle 24 at the first end 12 and the fuel pump 30, additive pump 32 and, in this embodiment, shows a temperature control means 34a which may comprise diesel heater, an electric heater, a solar powered heater 34. Attached to each nozzle 24, 26, is a conduit 24a, 26a through which a fluid 40 may be dispensed. In an embodiment, at least one of the nozzles 24, 25 is in fluid connection with a reversible motor 50 thereby providing means by which fluid 40 may be moved into or out of the nozzle 24, 26. In an embodiment, a 4 way valve 60 is included to facilitate movement of fluid 40 through the valve 60 in either of two directions, or to block movement of fluid through the valve 60.

FIG. 3 shows the fuel tank (first container) 6 with the additive container (second container) 8 removed. In one embodiment the fuel container 6 comprises a passageway 62 having a wall 62a. The wall 62a of the passageway 62 may be completely bounded within the fuel container 6 or may be a conduit separate from the fuel container 6, or alternatively, in yet another embodiment, may be partly comprised of the outside 6a of the fuel container 6 and, when the additive container 8 is replaced, the passageway 62 may partly be comprised of the outside 8a of the additive container 8. In either embodiment, a heater 34 or temperature control means may be provided. The heater 34 may comprise a heating element and/or may include a fan for moving heated fluid (either gaseous or liquid) from the heater 34 through the passageway 62 to maintain or heat the additive in the (or other fluid) in the second container 8. The heating element may, alternatively, comprise heat generated as a byproduct of a fan or motor employed to provide another function and which is in close enough proximity such that the heat it generates can be transmitted to the additive container 8. Such transmission may be direct or indirect.

In one embodiment, the second container 8 comprises dimensions smaller than the width of the lower assembly 2 thereby creating a gap 90 between the second container 8 and the upper assembly 4 and lower assembly 2, when assembled together. This gap 90 may be employed as a conduit storage area 90 where conduits 24a,26a (or one of the conduits) may be coiled and inserted during transit or otherwise for storage. Alternatively, a directional hose sleeve 80 may be provided. A conduit 24a, 26a is inserted through a directional hose sleeve 80 (or said sleeve may be applied to the conduit 24a or 26a). The sleeve 80 comprises construction and material of adequate strength to hold the conduit 24a, 26a in a specified position. For example, the sleeve 80 may comprise a pocket of material 80a and a hose sleeve securement 82 wherein said pocket 80a is shaped and the securement 82 is placed such that the conduit 26 is secured therein to cause the conduit to reverse its direction, bending the conduit in a “U”. The use of the securement 82 allows the conduit 24a, 26a to be easily stored in the conduit storage area 90.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to which fall within the scope of the claims.

For example, such modifications may include a flexible conduit 24a, 26a equipped with either an automatic or manual nozzle 24, 26, or one of each, may be provided. In other embodiments, a single nozzle 24 on one end is provided, and a connector 84 may be provided on the other.

The pumping means 30 or 32 may be 12V electric pumps or any other pump able to pump between about 5-25 or 35 gallons per minute. This flow rate is ideal for fluid delivery assemblies of the present invention; however, slower rates or faster rates would also facilitate the purpose of the invention. The suggested rates are for convenience but not intended to be for limitation.

In one embodiment, the first container 6 holds diesel fuel and the second container 8 holds diesel exhaust fluid (DEF). But the identity of the containers' contents need not be so limited. For any situation in which two pumpable but different liquids (or two volumes of the same liquid) need to be stored separately for reasons related to variant concentrations or temperatures, and are required to be transported and then unloaded separately one from the other, the present invention will provide utility.

In this example where the diesel and DEF are the fluids 40 to be transported, the pump capacity might be 10-15 gpm for diesel from the first container 6 and 5-10 gpm for DEF from the second container 8. These rates, too, may be adjusted according to the viscosity of the fluid and/or the intake capacity of the vessel to which the fluid is being removed, and also in accordance with the size and pumping capacity of the pump 30, 32 combined with the motor 50.

For example, the first container 6 may house diesel fuel and the second container 8 may house DEF. In this case the DEF container may have a capacity of about 20% of the volume of the diesel container since DEF is consumed at about 5% to about 8% rate, or at a ratio of about 0.1-0.2 to 1. The containers 6, 8 may be uniformly constructed of materials suitable for their respective intended uses. For example, a container that will contain DEF may be constructed of polyurethane or stainless steel. Other fluids may be better accommodated by containers made from other materials.

The lower assembly 2 is constructed to provide temperature control means 34 for at least one, if not both, of the first and second containers 6, 8. Temperature control means 34 may include a passageway 62 positioned to transfer heat to one or both of the first and second containers 6, 8. The temperature control means 34 may, alternatively or additionally, include a heating element 35 for heating a fluid 40 or other material and be equipped to facilitate moving the heated fluid 40 (which may alternatively comprise heated air) or other temperature specific material through the passageway 62. The heating element 35 may not be necessary if, instead, the assembly is mounted on a vehicle comprising a motor that may generate adequate heat as it is operated to move the vehicle. Or may comprise an auxiliary power source or capability that may be employed to power a heating element 35, or power a heater 34 equipped with a blower to move heated air. The vehicle (or an auxiliary motor) may comprise a heating element to provide passive transfer of heat to the fluid in one or both of the containers. In one embodiment, means to convey heat 70 comprises the heater 34 that warms air 102 and a fan 104 blows the warm air 102 through the passageway 62, thereby transferring heat to one or both of the first and second containers 6, 8. In this embodiment, the passageway 62 comprises an opening to allow the air to flow through and exit and/or recirculate past the heater 100. The first and second containers 6, 8 may be oriented side by side, or one over the other, or otherwise. The two tanks 6, 8 may be identical in construction or may vary in size as previously described, or may vary in heat-retaining capacity through insulation or the material with which the container is constructed.

However, the relative positions of the tanks (containers) 6, 8 are not so limited; side by side would also work well. Alternatively, an arrangement comprising one tank partially surrounding the other could accomplish the objectives of the invention as could other arrangements. For use in colder or warmer climates where maintaining temperature of the fluid in one or both of the containers 6, 8 is important, means to convey heat can be included. Means to convey heat 70 may include conduits 62 comprising circulating, temperature controlled liquid. Alternatively, the containers 6, 8 may be shaped and positioned to foster heat transfer between them, or may include a circulating liquid or gas 70 serving as means to convey heat. Means to convey heat 70 (which may comprise a gas or a liquid or any material capable of being moved and of transferring its heat to the second container/tank 8) and the temperature control means 34a and heater 34 are preferably, but not necessarily positioned so as to provide heat as necessary to the second container/tank 8. FIG. 2 again shows the nozzle 24 at the first end 12 and the fuel pump 32, additive pump 30 and, in this embodiment, shows a temperature control means 33 and may comprise a heat source 34 which may comprise any of a diesel heater, an electric heater, or a solar powered heater or other heating means known in the art 34. Attached to each nozzle 24, 26 is a conduit 24a, 26a through which a fluid 40 may be dispensed. In an embodiment at least one of the nozzles 24, 26 is in fluid connection with a reversible motor 50 thereby providing means by which fluid 40 may be moved into or out of the nozzle 24, 26. In an embodiment, a 4 way valve 60 is included to facilitate movement of fluid 40 through the valve 60 in either of two directions, or to block movement of fluid through the valve 60.

FIG. 2 shows the fuel tank (first container) 6 with the additive container (second container) 8 removed. In one embodiment the fuel container 6 comprises a passageway 62 having a wall 62a. The wall 62a of the passageway 62 may be completely bounded within the fuel container 6 or may be a conduit separate from the fuel container 6, or, alternatively, in yet another embodiment, may be partly comprised of the outside 6a of the fuel container 6 and, when the additive container 8 is replaced, the passageway 62 may partly be comprised of the outside 8a of the additive container 8. In either embodiment, a heater 34 or temperature control means is provided. The heater 34 may comprise a heating element and/or may include a fan for moving heated fluid (either gaseous or liquid) from the heater 34 through the passageway 62 to maintain or heat the additive in the (or other fluid) in the second container 8.

In one embodiment, the second container 8 comprises dimensions smaller than the width of the lower assembly 2 thereby creating a gap 90 between the second container 8 and the upper assembly 4 and lower assembly 2, when assembled together. This gap 90 may be employed as a conduit storage area 90 where conduits 26a, 28a (or one of the conduits) may be coiled and inserted during transit or otherwise for storage. Alternatively, or additionally, a directional conduit sleeve 80 may be provided. A conduit 26a or 26b, is inserted through a directional conduit sleeve 80 (or said sleeve may be applied to the conduit 26a or 26b). The sleeve 80 comprises construction and material of adequate strength to hold the conduit 26a, 28a in a specified position. For example, the sleeve 80 may comprise a pocket of material 80a and a conduit sleeve securement 82 wherein said pocket 80a is shaped and a securement 82 is placed such that the conduit 26a is secured therein to cause the conduit to reverse its direction, bending the conduit in a “U”. The use of the securement 82 allows the conduit 26a or 26b to be easily stored in the conduit storage area 90.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

1. A fluid delivery device for transporting fluid comprising a lower assembly and an upper assembly, said lower assembly including a first container and a second container said first container comprising a fuel, said second container comprising a fuel additive, said lower assembly further comprising a tank fill, at least one switch, at least one nozzle access, a fuel pump, an additive pump, and a temperature control means associated with at least one of said first container and said second container.

2. The fluid delivery device of claim 1 further comprising a reversible motor for moving fluid into or out of the nozzle, and a 4-way valve to facilitate movement of the fluid through the valve in any one of a first direction, a second direction, or stopped.

3. The fluid delivery device of claim 1 or 2, said temperature control means comprising a heater having a fan and a passageway through which the fan blows heated air, said passageway in heat-transfer contact with at least a portion of an outside of the second container thereby providing means to increase temperature or decrease temperature of said fuel additive in the second container.

4. A fluid delivery device comprising a lower assembly housing a first container and a second container, an upper assembly, a first fuel pump associated with one of the first and second containers, a first conduit and a first nozzle, a second fuel pump associated with the other of the first and second containers, a second conduit and a second nozzle, said device further comprising a temperature control means having a heater and a fan associated with a passageway bounded at least in part by an outer wall of the second container to provide means to circulate heated air thereby facilitating control of the temperature of fluid in the second container.

5. The fluid delivery device of claim 4 comprising a conduit storage area.

6. The fluid delivery device of claim 4 comprising a directional conduit sleeve.

7. The fluid delivery device of claim 6 wherein the directional conduit sleeve comprises a pocket and a conduit sleeve securement to secure the conduit through the pocket.
